(19) United States
(12) Patent Application Publication
(10) Pub. No.: US 2026/0005838 A1
(43) Pub. Date: Jan. 1, 2026

(54) FUNCTION EXECUTING DEVICE, NON-TRANSITORY COMPUTER-READABLE RECORDING MEDIUM STORING COMPUTER PROGRAM FOR FUNCTION EXECUTING DEVICE, AND METHOD FOR CONTROLLING FUNCTION EXECUTING DEVICE

(71) Applicant: BROTHER KOGYO KABUSHIKI KAISHA, Nagoya (JP)

(72) Inventor: Kyohei MORI, Nagoya (JP)

(21) Appl. No.: 19/250,147

(22) Filed: Jun. 26, 2025

(30) Foreign Application Priority Data
Jun. 28, 2024 (JP) 2024-104935

(51) Int. Cl. H04L 9/08; H04L 9/32

(52) U.S. Cl. CPC H04L 9/0825; H04L 9/3231; H04L 9/3247

(57) ABSTRACT

A function executing device may, in a case where an input of specific account information is accepted, send a first authentication request to a server. The function executing device may receive first verification information from the server, acquire first signature information, send the first signature information to the sever, receive a first function executing instruction from the server, and cause a function executing engine to execute a specific function. The function executing device may send, to the server, a second authentication request including predetermined information without accepting the input of account information. The function executing device may receive second verification information from the server, acquire second signature information, send the second signature information to the sever, receive a second function executing instruction from the server, and cause the function executing engine to execute the specific function.

### REFERENCE TO RELATED APPLICATION

This application claims priority to Japanese Patent Application No. 2024-104935 filed on Jun. 28, 2024. The entire content of the priority application is incorporated herein by reference.

### BACKGROUND ART

A system including an image processing device, an external authenticator, and a service provision system is known. When the image processing device accepts an operation for using a printing service, the image processing device sends a service provision request to the service provision system, receives a request for biometric authentication including ‘Assertion Challenge’, and sends an assertion creation request including the Assertion Challenge to the external authenticator. When the biometric authentication succeeds, the external authenticator encrypts the Assertion Challenge by using a private key and creates signature data. Then, the external authenticator sends assertion information including the signature data to the image processing device and the image processing device sends an assertion verification request including the assertion information to the service provision system. The service provision system decrypts the signature data included in the assertion information by using a public key, and determines that user authentication has succeeded when a decrypted value matches the Assertion Challenge, and sends a signal for providing the printing service to the image processing device.

### SUMMARY

The present teachings provide a novel art configured to cause a function executing device to execute a specific function in accordance with a predetermined authentication scheme using a pair of keys.

A function executing device disclosed in the disclosure is configured to operate according to a predetermined authentication scheme using a pair of keys. The function executing device may include: a function executing engine configured to execute a specific function; and a controller. The controller may be configured to, in a case where an input of specific account information is accepted, send a first authentication request including the specific account information to a server. The controller may be configured to, in response to the first authentication request being sent to the server, receive first verification information from the server. The controller may be configured to, in a case where an authentication for a target user using biometric information in a first memory succeeds and the first verification information is received from the server, acquire first signature information by encrypting the first verification information using a first private key in the first memory. The controller may be configured to send the first signature information to the sever. The server may be configured to decrypt the first signature information using a first public key stored in the server in association with the specific account information. The controller may be configured to, in a case where decryption of the first signature information succeeds in the server, receive a first function executing instruction from the server. The controller may be configured to, in a case where the first function executing instruction is received from the server, cause the function executing engine to execute the specific function. The controller may be configured to send, to the server, a second authentication request including predetermined information without accepting the input of account information. The controller may be configured to, in response to the second authentication request being sent to the server, receive second verification information from the server. The controller may be configured to, in a case where the authentication for the target user using the biometric information in the first memory succeeds and the second verification information is received from the server, acquire second signature information by encrypting the second verification information using a second private key in the first memory. The controller may be configured to send the second signature information to the sever. The server may be configured to decrypt the second signature information using a second public key stored in the server in association with the predetermined information. The controller may be configured to, in a case where decryption of the second signature information succeeds in the server, receive a second function executing instruction from the server. The controller may be configured to, in a case where the second function executing instruction is received from the server, cause the function executing engine to execute the specific function.

According to the above configuration, the function executing device accepts an input of the specific account information and sends the first authentication request to the server, and when authentication of the target user using the biometric authentication information in the first memory succeeds and decryption by the server of the first signature information succeeds, the function executing device executes the specific function. Also, the function executing device sends the second authentication request to the server, and when authentication of the target user using the biometric authentication information in the first memory succeeds and decryption by the server of the second signature information succeeds, the function executing device executes the specific function without accepting an input of the account information. Accordingly, the function executing device can execute the specific function in both cases where the input of the account information is accepted and where the input of the account information is not accepted.

Computer-readable instructions for the above-described function executing device, a non-transitory computer-readable recording medium storing computer-readable instructions for the above-described function executing device and a method executed by the function executing device are also novel and useful. Also, a communication system comprising the above-described function executing device and server is also novel and useful.

### BRIEF DESCRIPTION OF DRAWINGS

FIG. 1 illustrates a configuration of a communication system.

FIG. 2 illustrates an example of a table.

FIG. 3 illustrates a sequence diagram of a first registration process.

FIG. 4 illustrates a sequence diagram continued from FIG. 3.

FIG. 5 illustrates a sequence diagram continued from FIG. 4.

FIG. 6 illustrates a sequence diagram of a first printing process.

FIG. 7 illustrates a sequence diagram continued from FIG. 6.

FIG. 8 illustrates a sequence diagram of a second registration process.

FIG. 9 illustrates a sequence diagram continued from FIG. 8.

FIG. 10 illustrates a sequence diagram of a second printing process.

FIG. 11 illustrates a sequence diagram of a first printing process.

FIG. 12 illustrates a sequence diagram of a second printing process.

FIG. 13 illustrates a sequence diagram of a first printing process.

FIG. 14 illustrates a sequence diagram of a second printing process.

### DESCRIPTION

### First Embodiment

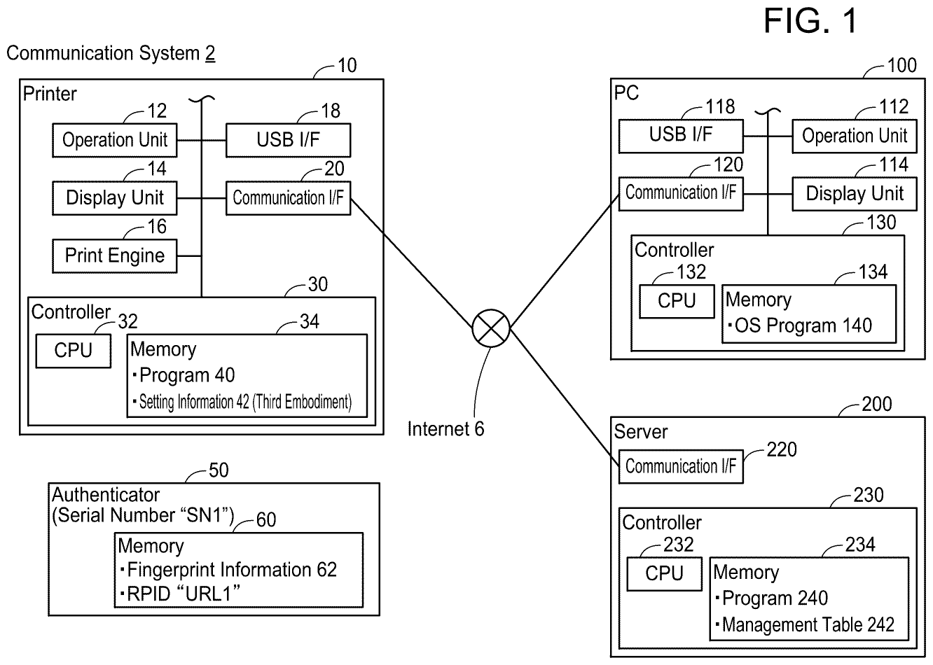

### Communication System 2; FIG. 1

As illustrated in FIG. 1, a communication system 2 comprises a printer 10, an authenticator 50, a PC 100, and a server 200. The printer 10, the PC 100, and the server 200 are connected to the Internet 6. The printer 10, the PC 100, and the server 200 are configured to communicate with each other via the Internet 6.

### Configuration of Printer 10

The printer 10 is a peripheral device (e.g., peripheral device for the PC 100) configured to execute a print function. The printer 10 is configured to operate in accordance with Fast Identity Online (FIDO) authentication scheme using a pair of keys. FIDO authentication scheme is an authentication scheme using a pair of keys, i.e., a private key and a public key. Also, FIDO authentication scheme uses biometric authentication (e.g., fingerprint authentication, voice authentication, face authentication) for authenticating a user, instead of authentication using a password. Hereafter, authentication according to FIDO authentication scheme will be referred to as “FIDO authentication”.

The printer 10 comprises an operation unit 12, a display unit 14, a print engine 16, a USB interface 18, a communication interface 20, and a controller 30. Hereafter, an interface will be referred to as “I/F”.

The operation unit 12 is a user interface configured to allow a user to input various information to the printer 10. The operation unit 12 comprises a touch panel for displaying software key(s) (operation area), hardware key(s), or both of them. The hardware key(s) include for example button(s) and/or switch(es). The display unit 14 is a display or a panel configured to display various information and/or various screens to be described later. The display is for example a liquid crystal display or an organic EL display. The panel may be a touch panel or may not be a touch panel. Also, the panel is for example a liquid crystal panel or an organic EL panel.

The print engine 16 is an electronic photo print engine, an inkjet print engine, or a thermal print engine. The inkjet print engine comprises a print head which ejects ink droplets. The electronic photo print engine comprises a photoreceptor and an exposure device which emits light to expose the photoreceptor. The thermal print engine comprises a print head which ejects heat with a heater.

The USB I/F 18 is an I/F to which a USB connector is to be connected. The communication I/F 20 is an I/F configured for communication with another device. The communication I/F 20 is connected to the Internet 6. The communication I/F 20 may be a wired I/F or may be a wireless I/F.

The controller 30 comprises a CPU 32 and a memory 34. The memory 34 comprises a primary storage and an auxiliary storage. Although this is an example, the primary storage includes a RAM and cache memory. Although this is an example, the auxiliary storage may be a ROM, flash memory, Solid State Drive (SSD), Hard Disk Drive (HDD), or a combination thereof. The auxiliary storage of the memory 34 has a program 40 stored therein. The CPU 32 realizes various processes in accordance with a program loaded from the auxiliary storage onto the primary storage.

### Configuration of Authenticator 50

The authenticator 50 is configured to operate in accordance with FIDO authentication scheme. The authenticator 50 functions as a so-called authenticator in FIDO authentication scheme. The authenticator 50 has a serial number “SN1”. A serial number is an identification number assigned upon production of an authenticator. The authenticator 50 comprises a USB cable (not illustrated) including an USB connector and a memory 60. The memory 60 comprises a primary storage and an auxiliary storage. The auxiliary storage of the memory 60 has fingerprint information 62 and an RPID “URL1” stored therein. The fingerprint information 62 is information related to a fingerprint of a user who uses the PC 100. Hereinafter, the user who uses the PC 100 may be referred to as “target user”. The RPID is information for identifying a service which executes authentication. Although this is an example, the RPID indicates a URL of the server 200.

### Configuration of PC 100

The PC 100 is a PC such as a desktop PC, a laptop PC, or a tablet PC. The PC 100 comprises an operation unit 112, a display unit 114, a USB I/F 118, a communication I/F 120, and a controller 130.

The operation unit 112 is a user interface which allows the user to input various information to the PC 100. The operation unit 112 comprises a touch panel for displaying software key(s) (operation area), hardware key(s), or both of them. The hardware key(s) include for example button(s) and/or switch(es). The display unit 114 is a display or a panel configured to display various information and/or various screens to be described later. The display is for example a liquid crystal display or an organic EL display. The panel may be a touch panel or may not be a touch panel. Also, the panel is for example a liquid crystal panel or an organic EL panel. The USB I/F 118 is an I/F to which a USB connector is to be connected. The communication I/F 120 is an I/F configured for communication with another device. The communication I/F 120 is connected to the Internet 6.

The controller 130 comprises a CPU 132 and a memory 134. The memory 134 comprises a primary storage and an auxiliary storage. The auxiliary storage of the memory 134 has an Operating System (OS) program 140 stored therein. The OS program 140 controls basic operations of the PC 100. The CPU 132 realizes various processes in accordance with a program loaded from the auxiliary storage onto the primary storage.

### Configuration of Server 200

The server 200 is a server disposed on the Internet 6, and is provided by a vendor of the printer 10. In a modification, the server 200 may be disposed on the Internet 6 by a different entity from the vendor. In another modification, the vendor may not prepare hardware of the server 200 by themselves, but may utilize an environment provided by an external cloud computing service. In this case, the vendor may realize the server 200 by preparing a program (i.e., software) for the server 200, and introducing the same in the above-mentioned environment. The server 200 is configured to operate in accordance with FIDO authentication scheme. The server 200 operates as a so-called authentication server in FIDO authentication scheme.

The server 200 operates as a server which provides a relay service related to the printer 10. The relay service is a service for operating the printer 10 through the server 200. In the relay service, the server 200 sends an instruction based on information received from a PC which the user occupies to the printer 10, by using extensible Messaging and Presence Protocol (XMPP). XMPP connection is a so-called fulltime connection. When the server 200 uses the XMPP connection, the server 200 is able to send a signal to the printer 10 beyond a firewall of a LAN to which the printer 10 belongs, even without receiving a request from the printer 10. Here, a method of the server 200 sending a request to the printer 10 may not be the XMPP connection, but may be another method. For example, Hypertext Transfer Protocol Secure (HTTPS) connection may be established between the printer 10 and the server 200.

The server 200 comprises a communication I/F 220 and a controller 230. The communication I/F 220 is an I/F configured for communication with another device. The communication I/F 220 is connected to the Internet 6. The controller 230 comprises a CPU 232 and a memory 234. The memory 234 comprises a primary storage and an auxiliary storage. The auxiliary storage of the memory 234 has a program 240 and a management table 242 stored therein. The CPU 232 realizes various processes in accordance with a program loaded from the auxiliary storage onto the primary storage.

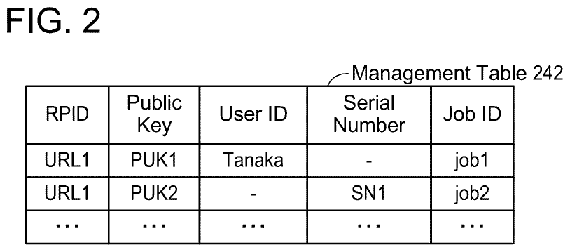

### Configuration of Management Table 242; FIG. 2

With reference to FIG. 2, a content of the management table 242 in the server 200 will be described.

The management table 242 is a table for managing information related to FIDO authentication. In the management table 242, an RPID, a public key, a user ID, a serial number, and a job ID are stored in association with each other. The public key is registered when a registration process for registering a pair of keys used for FIDO authentication is executed. The job ID is information for identifying a print job and is created when an upload request including a print file is received from the PC.

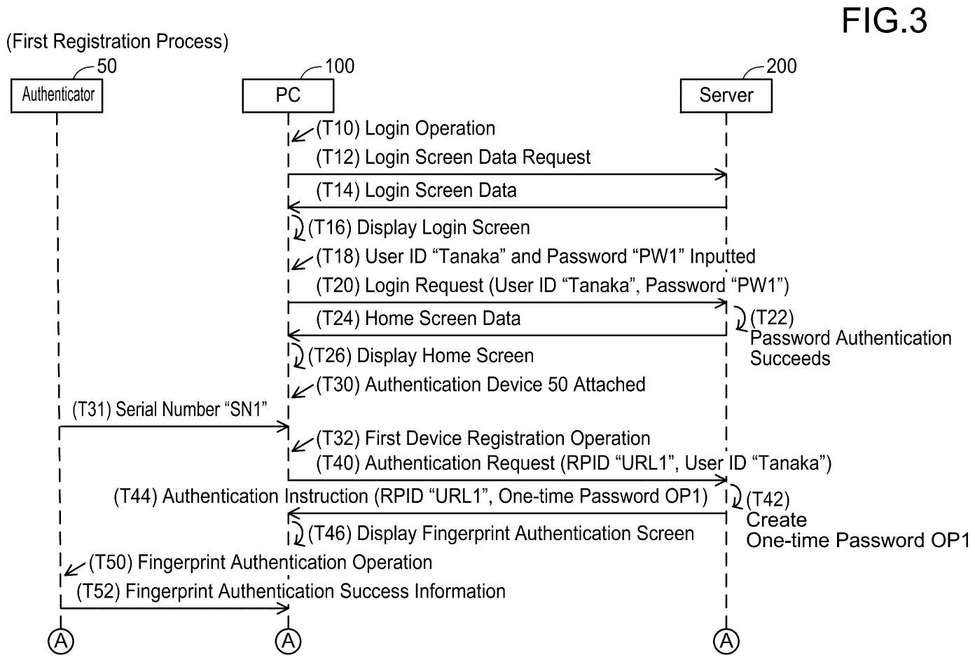

### First Registration Process; FIGS. 3 to 5

With reference to FIGS. 3 to 5, a first registration process for registering information related to FIDO authentication in each device will be described. The first registration process includes a process for registering a print job in the server 200. In the first registration process, the target user logs in to the server 200 by using a user ID “Tanaka” and a password “PW1”. In an initial state of FIG. 3, a combination of the user ID “Tanaka” and the password “PW1” is stored in the memory 234 of the server 200. Also, the management table 242 is in a blank state. Hereinafter, a process executed by a CPU of each device will be described with each device as a subject of action, without describing the CPU as subject of action. Also, hereinafter, communication between the respective devices will be performed via a communication I/F. Due to this, hereafter, when a process related to communication via a communication I/F is described, a description “via the communication I/F” will be omitted. Also, communication between the printer 10 and the authenticator 50 will be performed via the USB I/F 18 of the printer 10. Due to this, hereinafter, when a process related to communication via the USB I/F is described, a description “via the USB I/F 18” will be omitted.

In T10, the target user performs a login operation for logging in to the server 200 on the PC 100. Due to this, in T12 the PC 100 sends a login screen data request to the server 200. In T14, the PC 100 receives login screen data from the server 200. In T16 the PC 100 displays a login screen represented by the login screen data on the display unit 114. In T18, the user inputs the user ID “Tanaka” and the password “PW1” to the PC 100, i.e., on the login screen displayed on the display unit 114. Due to this, in T20, the PC 100 sends a login request including the user ID “Tanaka” and the password “PW1” to the server 200.

When the server 200 receives the login request from the PC 100 in T20, the server 200 determines in T22 that password authentication has succeeded because the combination of the user ID “Tanaka” and the password “PW1” in the login request is stored in the memory 234. Then, in T24, the server 200 sends home screen data to the PC 100.

When the PC 100 receives the home screen data from the server 200 in T24, the PC 100 displays a home screen represented by the home screen data on the display unit 114 in T26.

In T30, the target user connects the USB connector of the authenticator 50 to the USB I/F 118 of the PC 100. Due to this, the PC 100 determines that the authenticator 50 is connected to the PC 100. In T31, the PC 100 acquires the serial number “SN1” from the authenticator 50. In T32, the target user performs a first device registering operation for registering the information related to FIDO authentication to each device on the PC 100. Due to this, in T40, the PC 100 sends an authentication request including the user ID “Tanaka” and the RPID “URL1” to the server 200.

When the server 200 receives the authentication request from the PC 100 in T40, the server 200 creates a one-time password OP1 and stores the one-time password OP1 in the memory 234 in T42. In T44, the server 200 sends an authentication instruction including the RPID “URL1” and the one-time password OP1 to the PC 100. The authentication instruction is a signal for instructing execution of biometric authentication. When the PC 100 receives the authentication instruction from the server 200 in T44, the PC 100 displays a fingerprint authentication screen on the display unit 114 in T46. A message requesting for a fingerprint authentication using the authenticator 50 to be executed is displayed on the fingerprint authentication screen.

In T50, the target user performs a fingerprint authentication operation on the authenticator 50. Because fingerprint information acquired by the fingerprint authentication operation and the fingerprint information 62 in the memory 60 match, the authenticator 50 determines that the fingerprint authentication has succeeded, and in T52, the authenticator 50 sends fingerprint authentication success information indicating that the fingerprint authentication has succeeded to the PC 100.

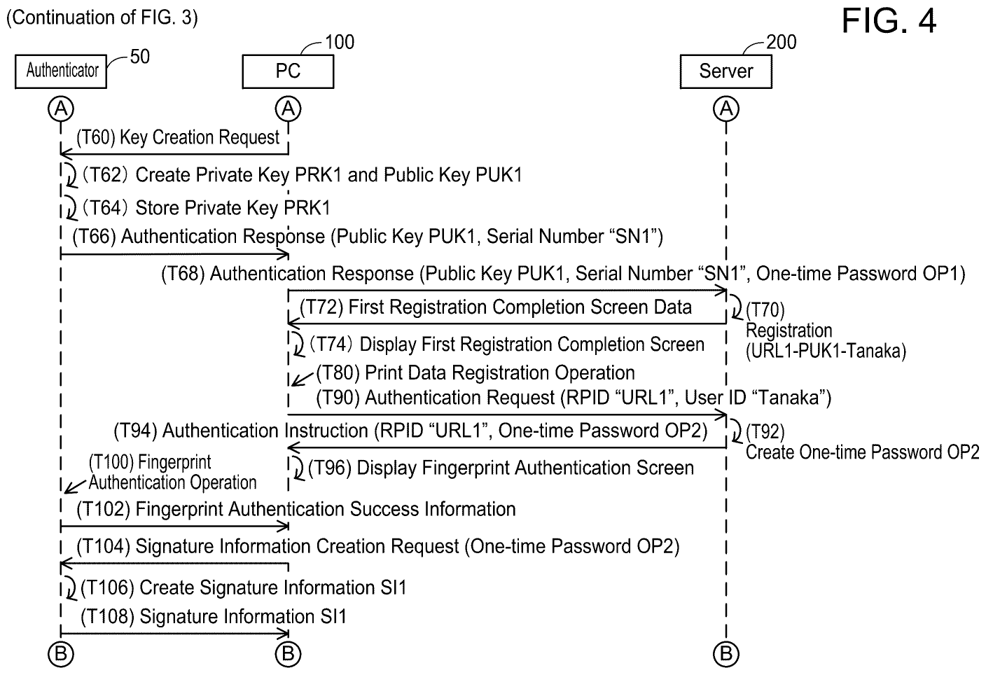

When the PC 100 receives the fingerprint authentication success information from the authenticator 50 in T52, the PC 100 sends a key creation request to the authenticator 50 in T60 in FIG. 4. The key creation request is a signal requesting to create a pair of keys used in FIDO authentication.

When the authenticator 50 receives the key creation request from the PC 100 in T60, the authenticator 50 creates a private key PRK1 and a public key PUK1 in T62. Then, in T64, the authenticator 50 stores the private key PRK1 in the memory 60. In T66, the authenticator 50 sends an authentication response including the public key PUK1 and the serial number “SN1” to the PC 100.

When the PC 100 receives the authentication response from the authenticator 50 in T66, the PC 100 sends the authentication response including the public key PUK1, the serial number “SN1”, and the one-time password OP1 to the server 200 in T68.

When the server 200 receives the authentication response from the PC 100 in T68, the server 200 determines that the one-time password OP1 in the authentication response and the one-time password OP1 in the memory 234 match, and specifies the public key PUK1 in the authentication response. In T70, the server 200 stores the RPID “URL1”, the public key PUK1, and the user ID “Tanaka” of the user who has logged in in association with each other in the management table 242. In T72, the server 200 sends first registration completion screen data to the PC 100.

When the PC 100 receives the first registration completion screen data from the server 200 in T72, the PC 100 displays a first registration completion screen represented by the first registration completion screen data on the display unit 114 in T74. The first registration completion screen includes a message indicating that registration of the information related to FIDO authentication has completed. Also, the first registration completion screen includes a message indicating that such information has been registered in association with the user ID.

In T80, the target user performs a print data registration operation for registering print data in the server 200 on the PC 100. Due to this, in T90, the PC 100 sends the authentication request including the user ID “Tanaka” and the RPID “URL1” to the server 200. T92, T94 are the same as T42, T44 in FIG. 3, respectively, except that a one-time password OP2 is used. T96, T100, T102 are the same as T46, T50, T52, respectively.

When the PC 100 receives the fingerprint authentication success information from the authenticator 50 in T102, the PC 100 sends a signature information creation request including the one-time password OP2 to the authenticator 50 in T104. The signature information creation request is a signal requesting to create signature information.

When the authenticator 50 receives the signature information creation request from the PC 100 in T104, the authenticator 50 specifies the private key PRK1 in the memory 60. In T106, the authenticator 50 creates signature information SI1 by encrypting the received one-time password OP2 with the specified private key PRK1, and in T108, the authenticator 50 sends the created signature information SI1 to the PC 100.

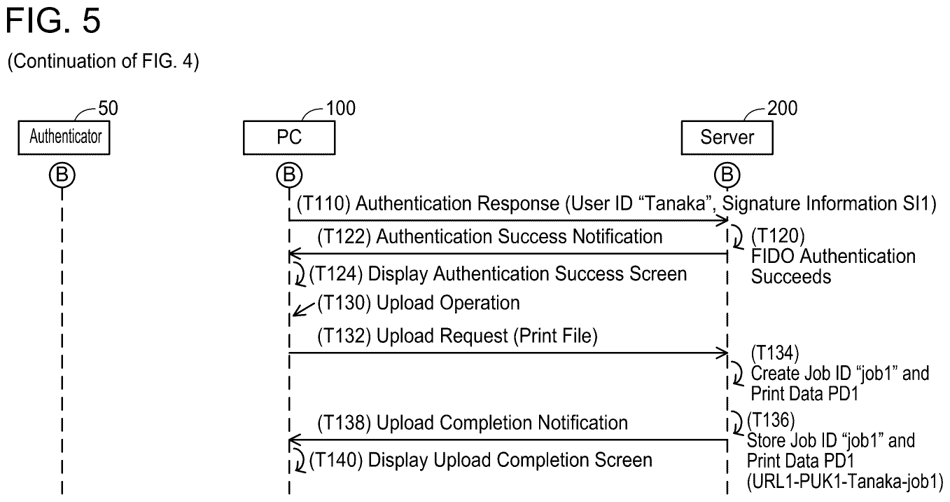

When the PC 100 receives the signature information SI1 from the authenticator 50 in T108, the PC 100 sends the authentication response including the user ID “Tanaka” and the signature information SI1 to the server 200 in T110 of FIG. 5.

When the server 200 receives the authentication response from the PC 100 in T110, the server 200 specifies the public key PUK1 stored in association with the user ID “Tanaka” in the management table 242. The server 200 decrypts the signature information SI1 in the authentication response by using the specified public key PUK1. Since the private key PRK1 and the public key PUK1 are a pair of keys, by decrypting the signature information SI1 with the public key PUK1, the one-time password OP2 can be acquired. The server 200 determines that the acquired one-time password OP2 and the one-time password OP2 (see T92 of FIG. 4) stored in the memory 234 match, and in T120 the server 200 determines that FIDO authentication has succeeded. In this case, the server 200 shifts from a logout state to a login state. By the server 200 shifting into the login state, the target user can upload a print file to the server 200. In T122, the server 200 sends an authentication success notification indicating that FIDO authentication has succeeded to the PC 100.

When the PC 100 receives the authentication success notification from the server 200 in T122, the PC 100 displays an authentication success screen on the display unit 114 in T124. Due to this, the target user can acknowledge that FIDO authentication has succeeded. In T130, the target user performs an upload operation for uploading the print file (print data in particular) to the server 200 on the PC 100. In the upload operation, the target user selects the print file to send. Due to this, in T132, the PC 100 sends an upload request including the print file as selected by the target user to the server 200.

When the server 200 receives the upload request from the PC 100 in T132, the server 200 creates in T134 a job ID “job1” and converts the print file in the request to create print data PD1 representing a print image having a data format which the printer 10 can interpret. In T136, the server 200 stores the created job ID “job1” in association with the received user ID “Tanaka” in the management table 242. The server 200 stores the print data PD1 in association with the job ID “job1” in the memory 234. In T138, the server 200 sends an upload completion notification indicating that uploading of the print file has been completed to the PC 100.

When the PC 100 receives the upload completion notification from the server 200 in T138, the PC 100 displays an upload completion screen on the display unit 114 in T140. Due to this, the target user can acknowledge that the uploading of the print file has completed. Although not illustrated, the PC 100 sends a logout request to the server 200. Due to this, the server 200 shifts from the login state to the logout state. As such, the print file is uploaded to the server 200 in response to the user logging in to the server 200 and FIDO authentication succeeding.

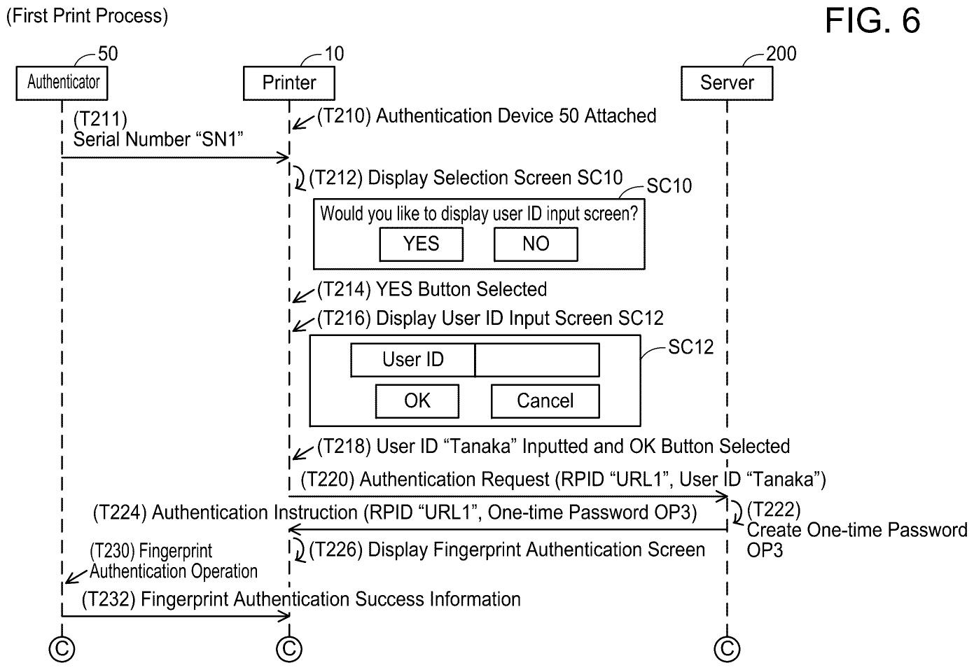

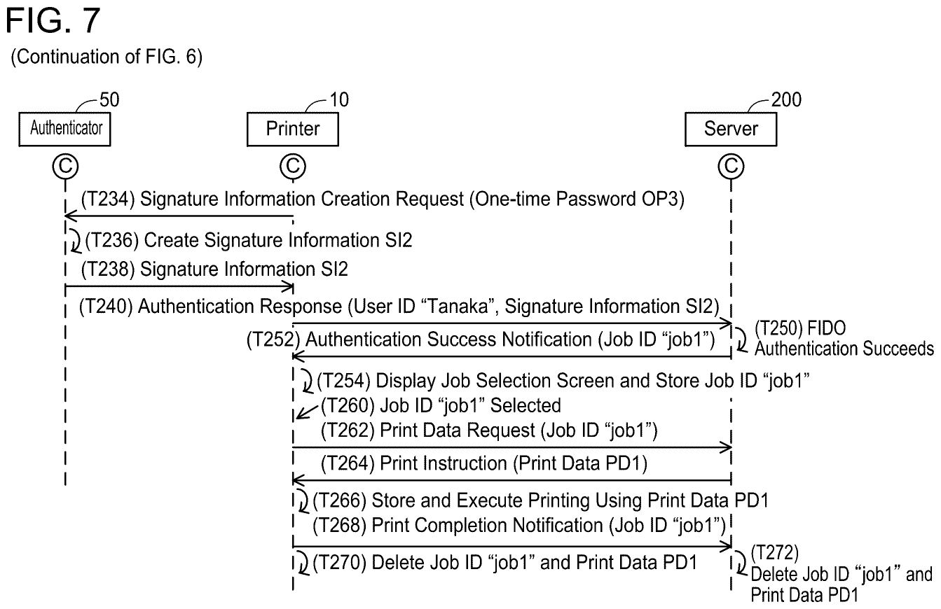

### First Print Process; FIGS. 6, 7

With reference to FIGS. 6 and 7, a first print process in which print data is downloaded from the server 200 in response to FIDO authentication succeeding will be described. An initial state of the first print process is a state after the first registration process in FIGS. 3 to 5. That is, the private key PRK1 is stored in the memory 60 of the authenticator 50. Also, the RPID “URL1”, the public key PUK1, the user ID “Tanaka”, and the job ID “job1” are stored in association with each other in the management table 242 of the server 200.

In T210, the target user connects the USB connector of the authenticator 50 to the USB I/F 18 of the printer 10. Due to this, the printer 10 determines that the authenticator 50 is connected to the printer 10. In T211, the printer 10 acquires the serial number “SN1” from the authenticator 50. In T212, the printer 10 displays a selection screen SC10 on the display unit 14. The selection screen SC10 is a screen for selecting whether or not to display a user ID input screen SC12 on the printer 10. That is, the selection screen SC10 is for the user to select whether to use the user ID or not. In T214, the target user performs an operation on an YES button on the selection screen SC10 on the printer 10. Due to this, in T216, the printer 10 displays the user ID input screen SC12 on the display unit 14. The user ID input screen SC12 is for inputting the user ID. In T218, the target user performs an operation of inputting the user ID “Tanaka” and an operation on an OK button on the printer 10. Due to this, in T220, the printer 10 sends the authentication request including the user ID “Tanaka” and the RPID “URL1” to the server 200. T222, T224 are the same as T42, T44 in FIG. 3 except that in T222, T224 a one-time password OP3 is used and communication target is the printer 10. Here, when the authentication request received from the printer 10 includes a user ID or serial number which is not stored in the management table 242, the server 200 sends an error response to the printer 10. T226, T230, T232 are respectively the same as T46, T50, T52 except that in T226, T230, T232 the communication target is the printer 10.

In T234 of FIG. 7, the authenticator 50 receives the signature information creation request including the one-time password OP3 from the printer 10, in T236, creates the signature information SI2 by encrypting the received one-time password OP3 by using the private key PRK1 in the memory 234, and in T238 sends the created signature information SI2 to the printer 10.

When the printer 10 receives the signature information SI2 from the authenticator 50 in T238, the printer 10 sends the authentication response including the user ID “Tanaka” and the signature information SI2 to the server 200 in T240.

When the server 200 receives the authentication response from the printer 10 in T240, the server 200 specifies the public key PUK1 stored in association with the user ID “Tanaka” in the management table 242. The server 200 acquires the one-time password OP3 by decrypting the signature information SI2 in the authentication response by using the specified public key PUK1. The server 200 determines that the acquired one-time password OP3 and the one-time password OP3 stored in the memory 234 (see T222 in FIG. 6) match, and in T250, the server 200 determines that FIDO authentication has succeeded. Due to this, the server 200 shifts from the logout state to the login state. In this case, the server 200 specifies the job ID “job1” stored in association with the user ID “Tanaka” in the management table 242, and in T252 the server 200 sends the authentication success notification including the specified job ID “job1” to the printer 10.

When the printer 10 receives the authentication success notification from the server 200 in T252, the printer 10 displays a job selection screen including the received job ID “job1” on the display unit 14, and stores the received job ID “job1” in the memory 34 in T254. The job selection screen is for the user to select which job ID to be printed. In T260, the target user selects the job ID “job1” in the job selection screen. Due to this, in T262, the printer 10 sends a print data request including the selected job ID “job1” to the server 200.

When the server 200 receives the print data request from the printer 10 in T262, the server 200 specifies the print data PD1 stored in association with the job ID “job1” in the memory 234, and in T264 sends a print instruction including the specified print data PD1 to the printer 10.

When the printer 10 receives the print instruction from the server 200 in T264, the printer 10 stores the print data PD1 in the print instruction in association with the job ID “job1” in the memory 234 in T266, and executes printing using the print data PD1. In T268, the printer 10 sends a print completion notification including the job ID “job1” to the server 200, and in T270 deletes the job ID “job1” and the print data PD1 from the memory 34.

When the server 200 receives the print completion notification from the printer 10 in T268, the server 200 deletes the job ID “job1” from the management table 242 and also deletes the print data PD1 from the memory 234 in T272. Although not illustrated, when the authenticator 50 is removed by the target user from the printer 10, the printer 10 sends the logout request to the server 200. Then when the server 200 receives the logout request from the printer 10, the server 200 shifts from the login state to the logout state. As such, printing is executed in response to the user ID “Tanaka” being inputted by the target user.

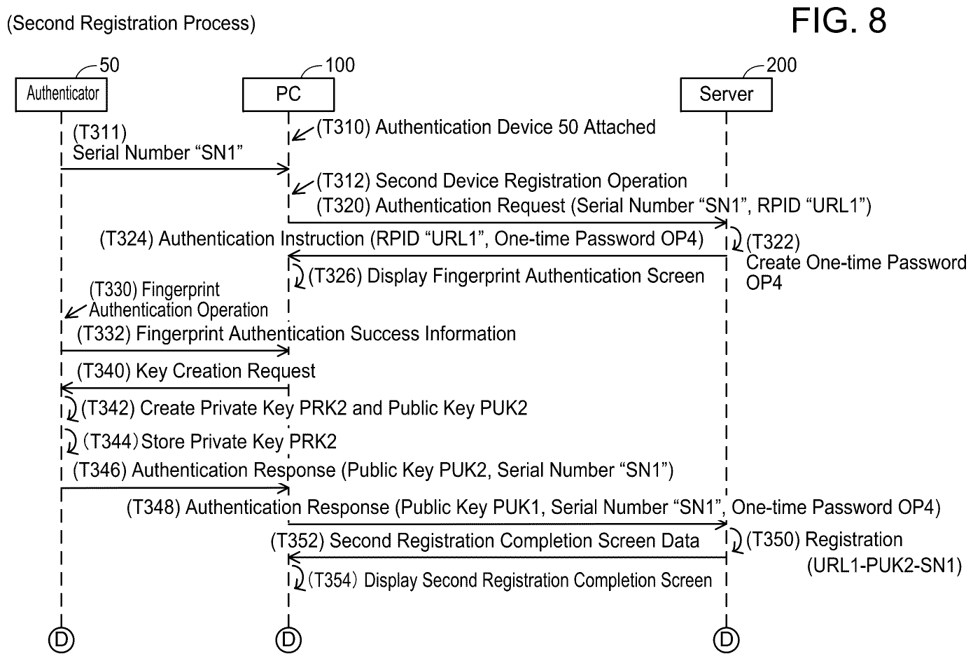

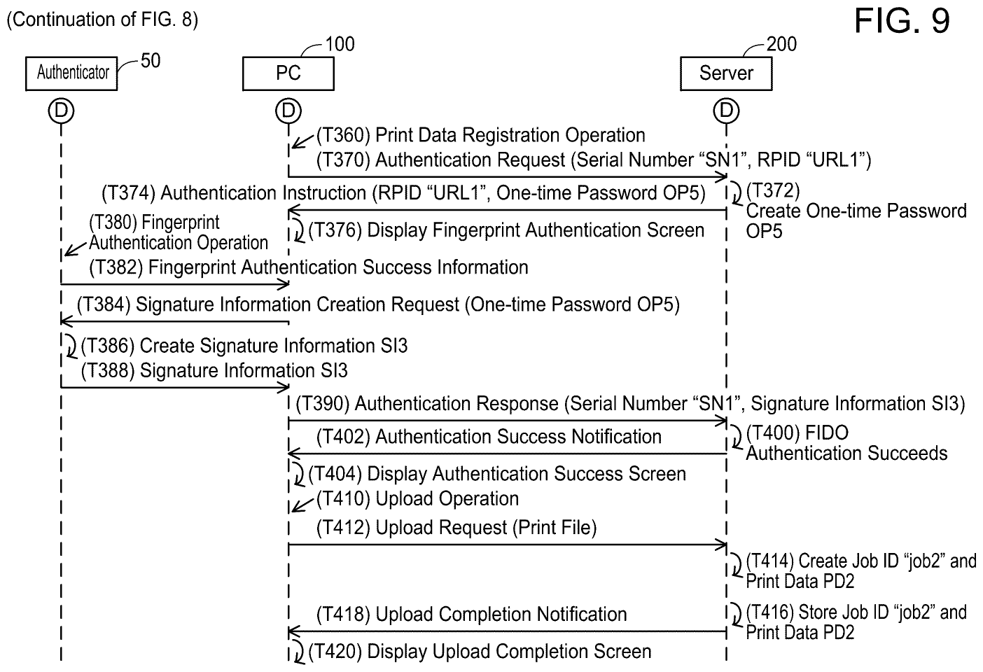

### Second Registration Process; FIGS. 8, 9

With reference to FIGS. 8 and 9, a second registration process for registering information related to FIDO authentication in each device will be described. In the second registration process, the target user does not perform the operation for logging in to the server 200 by using the user ID “Tanaka” and the password “PW1”. An initial state of the second registration process is the same as the first registration process in FIGS. 3 to 5.

T310, T311 are the same as T30, T31 in FIG. 3. In T312, the target user performs a second device registration operation for registering information related to FIDO authentication to each device on the PC 100. In T320, the PC 100 sends an authentication request including the serial number “SN1” and the RPID “URL1” to the server 200. T322 to T332 are the same as T42 to T52 in FIG. 3 except that a one-time password OP4 is used in T322 to T332.

When in T340 the authenticator 50 receives a key creation request from the PC 100, in T342 the authenticator 50 creates a private key PRK2 and a public key PUK2. Then, in T344, the authenticator 50 stores the private key PRK2 in the memory 60. In T346, the authenticator 50 sends a first authentication response including the public key PUK2 and the serial number “SN1” to the PC 100.

When the PC 100 receives the authentication response from the authenticator 50 in T346, the PC 100 sends the authentication response including the public key PUK2, the serial number “SN1”, and a one-time password OP4 to the server 200 in T348.

When the server 200 receives the authentication response from the PC 100 in T348, the server 200 determines that the one-time password OP4 in the second authentication response and the one-time password OP4 in the memory 234 match, and that the target user is not logged in to the server 200. In this case, in T350 the server 200 stores the RPID “URL1”, the public key PUK2, and the serial number “SN1” in association with each other in the management table 242. In T352, the server 200 sends second registration completion screen data to the PC 100. When the PC 100 receives the second registration completion screen data from the server 200 in T352, the PC 100 displays a second registration completion screen represented by the second registration completion screen data on the display unit 114 in T354. The second registration completion screen includes a message indicating that registration of the information related to FIDO authentication has completed. Also, the second registration completion screen includes information indicating that the user ID is not associated with such information.

T360 to T384 in FIG. 9 are the same as T80 to T104 in FIG. 4 except that in T360 to T384 a one-time password OP5 is used.

When the authenticator 50 receives the signature information creation request from the PC 100 in T384, the authenticator 50 creates signature information SI3 in T386 by encrypting the received one-time password OP5 by using the private key PRK2 in the memory 60, and in T388 sends the created signature information SI3 to the PC 100.

When the PC 100 receives the signature information SI3 from the authenticator 50 in T388, the PC 100 sends the authentication response including the serial number “SN1” and the signature information SI3 to the server 200 in T390.

When the server 200 receives the authentication response from the PC 100 in T390, the server 200 specifies the public key PUK2 stored in association with the serial number “SN1” in the management table 242. The server 200 acquires the one-time password OP5 by decrypting the signature information SI3 in the authentication response by using the specified public key PUK2. The server 200 determines that the acquired one-time password OP5 and the one-time password OP5 stored in the memory 234 (see T372) match, and in T400 determines that FIDO authentication has succeeded. In this case, the server 200 shifts from the logout state to the login state. T402, T404, T410, T412 are respectively the same as T122, 124, 130, T132 in FIG. 5.

When the server 200 receives the upload request from the PC 100 in T412, the server 200 creates a job ID “job2” and creates print data PD2 in T414. In T416, the server 200 stores the created job ID “job2” in association with the received serial number “SN1” in the management table 242. The server 200 stores the print data PD2 in the memory 234 in association with the job ID “job2”. T418, T420 are respectively the same as T138, T140 in FIG. 5. As such, even when the target user does not log in to the server 200, the print file is uploaded to the server 200 in response to FIDO authentication succeeding.

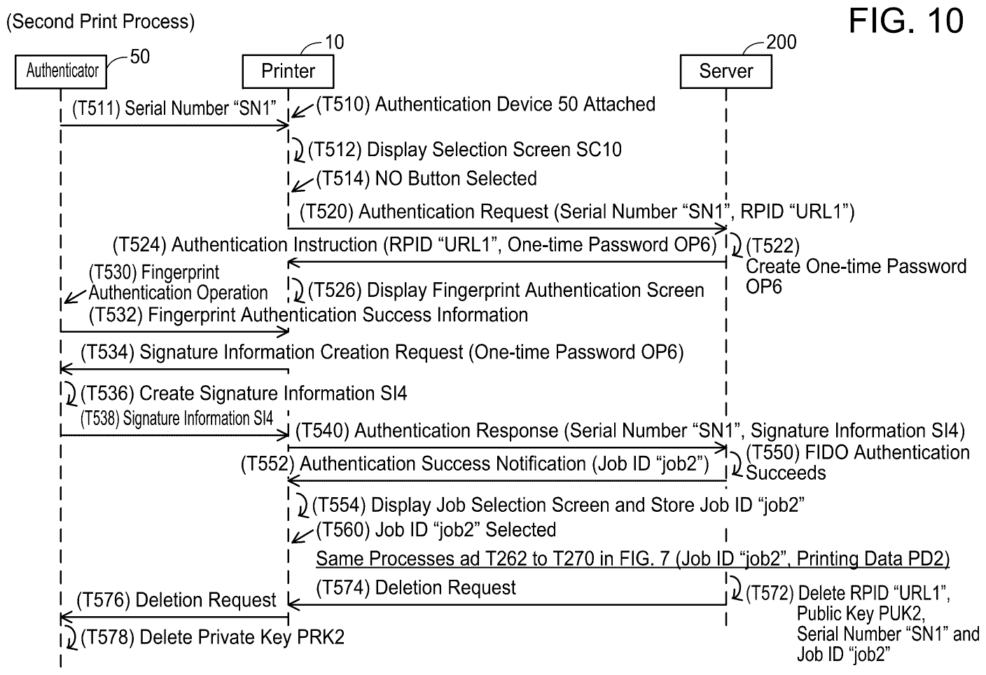

### Second Print Process; FIG. 10

With reference to FIG. 10, a second print process of print data being downloaded from the server 200 in response to FIDO authentication succeeding will be described. An initial state of the second print process is a state after the second registration process of FIGS. 8 and 9. That is, the memory 60 of the authenticator 50 has the private key PRK2 stored therein. Further, the RPID “URL1”, the public key PUK2, the serial number “SN1”, and the job ID “job2” are stored in association with each other in the management table 242 of the server 200.

T510 to T512 are the same as T210 to T212 in FIG. 6. In the present process, in T514, the target user performs an operation on a NO button on the selection screen SC10 on the printer 10. Due to this, in T520 the printer 10 sends an authentication request including the serial number “SN1” and the RPID “URL1” to the server 200 without displaying the user ID input screen SC12. T522, T524 are the same as T322, T324 in FIG. 8 except that in T522, T524 a one-time password OP6 is used and the communication target is the printer 10. T526, T530, T532 are respectively the same as T326, T330, T332.

In T534 the authenticator 50 receives the signature information creation request including the one-time password OP6 from the printer 10, then in T536 creates signature information SI4 by encrypting the received one-time password OP6 by using the private key PRK2 in the memory 234, and in T538 sends the created signature information SI4 to the printer 10.

When the printer 10 receives the signature information SI4 from the authenticator 50 in T538, the printer 10 sends an authentication response including the serial number “SN1” and the signature information SI4 to the server 200 in T540.

When the server 200 receives the authentication response from the printer 10 in T540, the server 200 specifies the public key PUK2 stored in association with the serial number “SN1” in the management table 242. The server 200 acquires the one-time password OP6 by decrypting the signature information SI4 in the authentication response by using the specified public key PUK2. The server 200 determines that the acquired one-time password OP6 and the one-time password OP6 stored in the memory 234 (see T522) match, and in T550, determines that FIDO authentication has succeeded. Due to this, the server 200 shifts from the logout state to the login state. In this case, the server 200 specifies the job ID “job2” stored in association with the serial number “SN1” in the management table 242 and in T552 sends the authentication success notification including the specified job ID “job2” to the printer 10.

When the printer 10 receives the authentication success notification from the server 200 in T552, the printer 10 displays the job selection screen including the received job ID “job2” on the display unit 14, and stores the received job ID “job2” in the memory 34 in T554. In T560, the target user selects the job ID “job2” in the job selection screen. Thereafter, processes that are the same as T262 to T270 in FIG. 7 are executed between the printer 10 and the server 200. Here, in these processes, the job ID “job2” and the print data PD2 are used.

In T572 the server 200 deletes the RPID “URL1”, the public key PUK2, the serial number “SN1”, and the job ID “job2” from the management table 242, and deletes the print data PD2 from the memory 234. In T574, the server 200 sends a deletion request requesting a private key to be deleted to the printer 10.

When the printer 10 receives the deletion request from the server 200 in T574, the printer 10 sends the deletion request to the authenticator 50 in T576.

When the authenticator 50 receives the deletion request from the printer 10 in T576, the authenticator 50 deletes the private key PRK2 in the memory 60 in T578. As such, printing is executed without a user ID being inputted by the target user.

As described above, when the decryption of the signature information SI4 succeeds, the server 200 deletes the serial number “SN1” and the public key PUK2 that are stored in the server 200 (T572 in FIG. 10). According to such configuration, the authenticator 50 can be shared. In the meantime, as illustrated in FIG. 7, even when the decryption of the signature information SI2 succeeds, the server 200 does not delete the user ID “Tanaka” and the public key PUK1 that are stored in the server 200 (T572 in FIG. 10). According to such configuration, the target user does not need to perform the operation of registering the information related to FIDO authentication again when the target user is to upload a new print file to the server 200. Accordingly, user convenience can be improved.

### Effects by Present Embodiment

As illustrated in FIGS. 6 and 7, the printer 10 accepts the input of the user ID “Tanaka” (T218 in FIG. 6), sends the authentication request including the user ID “Tanaka” to the server 200 (T220), and executes the print function (T266) when the authentication of the target user by using the fingerprint information 62 in the memory 60 of the authenticator 50 succeeds (T230 in FIG. 6) and also the decryption by the server 200 of the signature information SI2 succeeds (T250 in FIG. 7). Also, as illustrated in FIG. 10, the printer 10 sends the authentication request including the serial number “SN1” to the server 200 (T520 in FIG. 10), and executes the print function without accepting the input of a user ID when the authentication of the target user using the fingerprint information 62 succeeds (T530) and also the decryption by the server 200 of the signature information SI4 succeeds (T550). Accordingly, the printer 10 can execute the print function in both cases where the input of a user ID is accepted and where the input of a user ID is not accepted.

Security level can be improved by using a user ID as compared to the configuration where the user ID is not used. Also, user convenience can be improved by not using a user ID because the input of the user ID is not necessary. According to the above configuration, it is possible to select as needed, whether to use a method with higher security level or a method with greater user convenience.

Also, when the authenticator 50 is mounted on the printer 10, the printer 10 displays the selection screen SC10 on the display unit 14. According to such configuration, the target user can select whether to use a user ID or not. Accordingly, user convenience can be improved.

### Correspondence Relationships

FIDO authentication scheme is an example for “predetermined authentication scheme”. The printer 10 is an example for “function executing device”. The print function is an example for “specific function”. The print engine 16 is an example for “function executing engine”. The user ID “Tanaka” is an example for “specific account information”. The authentication request in T220 in FIG. 6 is an example for “first authentication request”. The one-time password OP3 in T224 in FIG. 6 is an example for “first verification information”. The memory 60 of the authenticator 50 is an example for “first memory”. The fingerprint information 62 is an example for “biometric authentication information”. The private key PRK1 is an example for “first private key”. The signature information SI2 in T238 in FIG. 7 is an example for “first signature information”. The public key PUK1 is an example for “first public key”. The print instruction in T264 in FIG. 7 is an example for “first function executing instruction”. The user ID is an example for “account information”. The serial number “SN1” is an example for “predetermined information”. The authentication request in T520 in FIG. 10 is an example for “second authentication request”. The one-time password OP6 in T524 in FIG. 10 is an example for “second verification information”. The private key PRK2 is an example for “second private key”. The signature information SI4 in T538 in FIG. 10 is an example for “second signature information”. The public key PUK2 is an example for “second public key”. The print instruction in T264 in FIG. 7, which is mentioned in FIG. 10, is an example for “second function executing instruction”. T210 in FIGS. 7 and T510 in FIG. 10 are examples for “predetermined operation”. The USB I/F 18 of the printer 10 is an example for “interface”. The serial number “SN1” is an example for “device identification information”.

T220 in FIG. 6 is an example for a process executed by “send a first authentication request”. T224 in FIG. 6 is an example for a process executed by “receive first verification information”. T238 in FIG. 7 is an example for a process executed by “acquire first signature information”. T240 in FIG. 7 is an example for a process executed by “send the first signature information”. T264 in FIG. 7 is an example for a process executed by “receive a first function executing instruction”. T266 in FIG. 7 is an example for a process executed by “in a case where the first function executing instruction is received from the server, cause the function executing engine to execute the specific function”. T520 in FIG. 10 is an example for a process executed by “send, to the server, a second authentication request”. T524 in FIG. 10 is an example for a process executed by “receive second verification information”. T538 in FIG. 10 is an example for a process executed by “acquire second signature information”. T540 in FIG. 10 is an example for a process executed by “send the second signature information”. T264 in FIG. 7, which is mentioned in FIG. 10, is an example for a process executed by “receive a second function executing instruction”. T266 in FIG. 7, which is mentioned in FIG. 10, is an example for a process executed by “in a case where the second function executing instruction is received from the server, cause the function executing engine to execute the specific function”.

### Second Embodiment

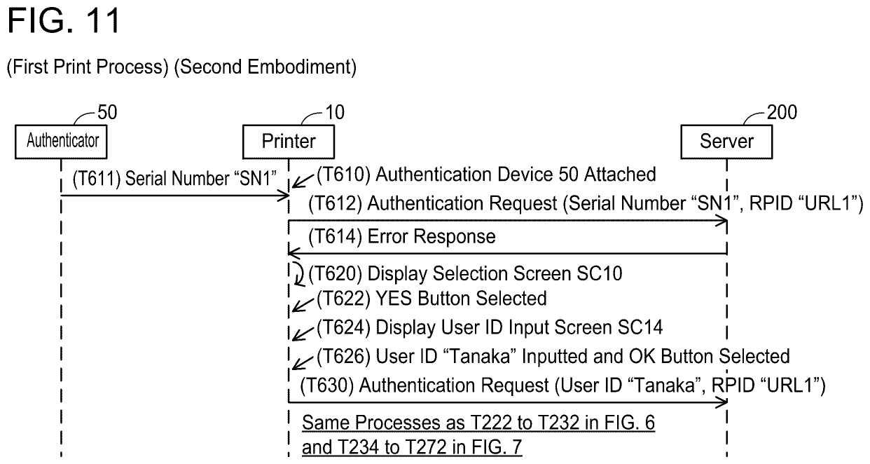

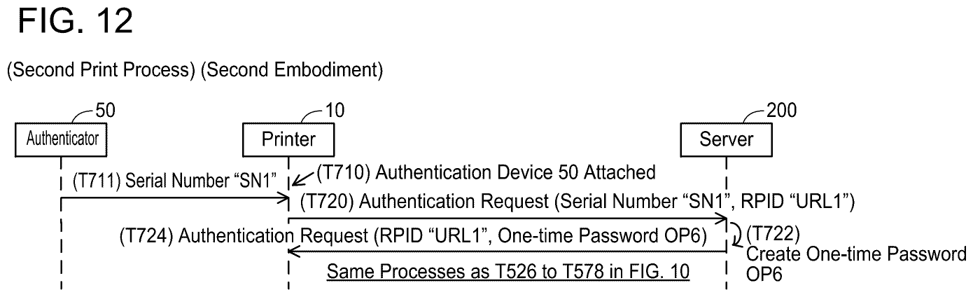

With reference to FIGS. 11 and 12, a second embodiment will be described. In the second embodiment, processes executed by the printer 10 in the first print process and the second print process are different from those in the first embodiment.

### First Print Process; FIG. 11

With reference to FIG. 11, a first print process will be described. An initial state of the first print process is the same as the initial state of the first print process in FIGS. 6 and 7.

T610, T611 are respectively the same as T210, T211 in FIG. 6. In T612, the printer 10 in the present embodiment sends an authentication request including the serial number “SN1 and the RPID “URL1” to the server 200 without displaying the selection screen SC10 and the user ID input screen SC12.

When the server 200 receives the authentication request from the printer 10 in T612, the server 200 specifies the serial number “SN1” in the authentication request and determines that the serial number “SN1” is not stored in the management table 242. In this case, in T614 the server 200 sends an error response to the printer 10.

When the printer 10 receives the error response from the server 200 in T614, the printer 10 displays the selection screen SC10 on the display unit 14 in T620. T622, T624, T626, T630 are respectively the same as T214, T216, T218, T220 in FIG. 6. Thereafter, processes that are the same as T222 to T232 in FIGS. 6 and T234 to T272 in FIG. 7 are executed between the printer 10 and the server 200.

### Second Print Process; FIG. 12

With reference to FIG. 12, a second print process will be described. An initial state of the second print process is the same as the second print process in FIG. 10.

T710, T711, T720 are respectively the same as T510, T511, T520 in FIG. 10.

When the server 200 receives the authentication request from the printer 10 in T720, the server 200 specifies the serial number “SN1” in the authentication request, and determines that the serial number “SN1” is stored in the management table 242. In this case, in T722, the server 200 creates the one-time password OP6 and stores the one-time password OP6 in the memory 234, and in T724 sends an authentication instruction including the RPID “URL1” and the one-time password OP6 to the PC 100.

Thereafter, processes that are the same as T526 to T578 in FIG. 10 are executed between the printer 10 and the server 200.

According to the above configuration, the target user does not need to perform an operation on a selection screen or the like in the second print process. Accordingly, user convenience can be improved.

### Correspondence Relationships

The authentication request in T630 in FIG. 11 is an example for “first authentication request”. The authentication request T720 in FIG. 12 is an example for “second authentication request”. T610 in FIGS. 11 and T710 in FIG. 12 are examples for “predetermined operation”.

T630 in FIG. 11 is an example for a process executed by “send a first authentication request”. T224 in FIG. 6, which is mentioned in FIG. 11, is an example for a process executed by “receive first verification information”. T238 in FIG. 7, which is mentioned in FIG. 11, is an example for a process executed by “acquire first signature information”. T240 in FIG. 7, which is mentioned in FIG. 11, is an example for a process executed by “send the first signature information”. T264 in FIG. 7, which is mentioned in FIG. 11, is an example for a process executed by “receive a first function executing instruction”. T266 in FIG. 7, which is mentioned in FIG. 11, is an example for a process executed by “in a case where the first function executing instruction is received from the server, cause the function executing engine to execute the specific function”. T720 in FIG. 12 is an example for a process executed by “send, to the server, a second authentication request”. T724 in FIG. 12 is an example for a process executed by “receive second verification information”. T538 in FIG. 10, which is mentioned in FIG. 12, is an example for a process executed by “acquire second signature information”. T540 in FIG. 10, which is mentioned in FIG. 12, is an example for a process executed by “send the second signature information”. T564 in FIG. 10, which is mentioned in FIG. 12, is an example for a process executed by “receive a second function executing instruction”. T566 in FIG. 10, which is mentioned in FIG. 12, is an example for a process executed by “in a case where the second function executing instruction is received from the server, cause the function executing engine to execute the specific function”.

### Third Embodiment

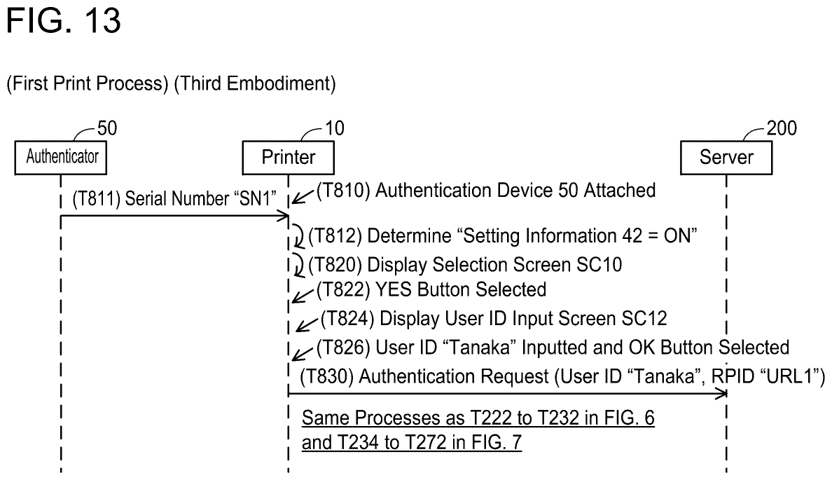

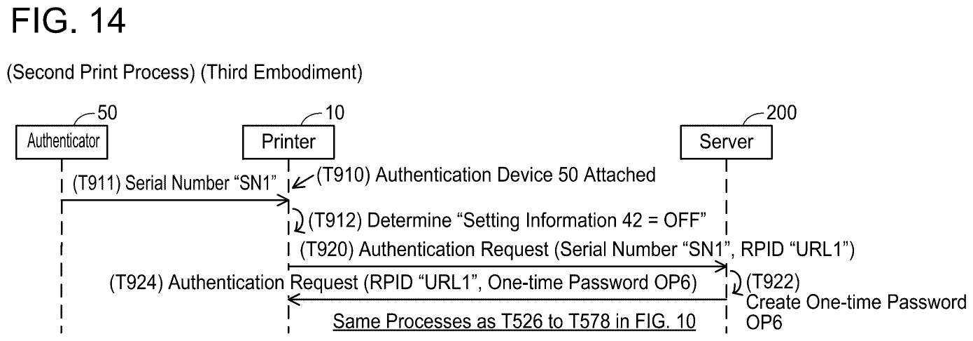

With reference to FIGS. 13 and 14, a third embodiment will be described. In the third embodiment, processes executed by the printer 10 in the first print process and the second print process are different from those in the first and second embodiments. Also, as illustrated in FIG. 1, the memory 34 of the printer 10 in the present embodiment has setting information 42 stored therein. The setting information 42 is for designating whether to use a user ID or not. Specifically, the setting information 42 is for setting whether to display the selection screen SC10 and the user ID input screen SC12 on the display unit 14 of the printer 10 or not when an authenticator is mounted on the printer 10. The setting information 42 indicates either “ON” indicating that use of the user ID is designated or “OFF” indicating that non-use of the user ID is designated. The setting information 42 is set by an administrator of the printer 10.

### First Print Process; FIG. 13

With reference to FIG. 13, a first print process will be described. An initial state of the first print process is the same as the initial state of the first print process in FIGS. 6 and 7 except that in FIG. 13 the setting information 42 is “ON”.

T810, T811 are respectively the same as T210, T211 in FIG. 6. In T812, the printer 10 determines that the setting information 42 in the memory 34 is “ON”, and in T820 displays the selection screen SC10 on the display unit 14. T822, T824, T826, T830 are respectively the same as T214, T216, T218, T220 in FIG. 6. Thereafter, processes that are the same as T222 to T232 in FIGS. 6 and T234 to T272 in FIG. 7 are executed between the printer 10 and the server 200.

### Second Print Process; FIG. 14

With reference to FIG. 14, a second print process will be described. An initial state of the second print process is the same as the initial state of the second print process in FIG. 10 except that in FIG. 14 the setting information 42 is “OFF”.

T910, T911 are respectively the same as T510, T511 in FIG. 10. In T912, the printer 10 determines that the setting information 42 in the memory 34 is “OFF”, and in T920, without displaying the selection screen SC10, sends the authentication request including the serial number “SN1” and the RPID “URL1” to the server 200. T922, T924 are respectively the same as T522, T524 in FIG. 10. Thereafter, processes that are the same as T526 to T578 in FIG. 10 are executed between the printer 10 and the server 200.

According to the above configuration, the administrator of the printer 10 can suitably set whether to use a user ID or not by setting the setting information 42.

### Correspondence Relationships

The authentication request in T830 in FIG. 13 is an example for “first authentication request”. The authentication request in T920 in FIG. 14 is an example for “second authentication request”. “ON” in the setting information 42 is an example for “first value”. “OFF” in the setting information 42 is an example for “second value”. The memory 34 of the printer 10 is an example for “second memory”.

T830 in FIG. 13 is an example for a process executed by “send a first authentication request”. T224 in FIG. 6, which is mentioned in FIG. 13, is an example for a process executed by “receive first verification information”. T238 in FIG. 7, which is mentioned in FIG. 13, is an example for a process executed by “acquire first signature information”. T240 in FIG. 7, which is mentioned in FIG. 13, is an example for a process executed by “send the first signature information”. T264 in FIG. 7, which is mentioned in FIG. 13, is an example for a process executed by “receive a first function executing instruction”. T266 in FIG. 7, which is mentioned in FIG. 13, is an example for a process executed by “in a case where the first function executing instruction is received from the server, cause the function executing engine to execute the specific function”. T920 in FIG. 14 is an example for a process executed by “send, to the server, a second authentication request”. T924 in FIG. 14 is an example for a process executed by “receive second verification information”. T538 in FIG. 10, which is mentioned in FIG. 14, is an example for a process executed by “acquire second signature information”. T540 in FIG. 10, which is mentioned in FIG. 14, is an example for a process executed by “send the second signature information”. T564 in FIG. 10, which is mentioned in FIG. 14, is an example for a process executed by “receive a second function executing instruction”. T566 in FIG. 10, which is mentioned in FIG. 14, is an example for a process executed by “in a case where the second function executing instruction is received from the server, cause the function executing engine to execute the specific function”.

(First Modification) The “function executing device” may not be limited to a printer, but may be a scanner, an MFP, for example. When the scanner is “function executing device”, a scan function is an example for “specific function”, and a scan engine is an example for “function executing engine”. Also, when the MFP is an example for “function executing device”, a print function, scan function or a facsimile function is an example for “specific function”, and a print engine, a scan engine, or a facsimile engine is an example for “function executing engine”.

(Second Modification) The “account information” may not be limited to a user ID, but may be a combination of a user ID and a password, for example.

(Third Modification) The “biometric authentication information” may not be limited to the fingerprint authentication information, but may be voice authentication information, face authentication information, for example.

(Fourth Modification) The printer 10 may comprise an accepting part configured to accept a fingerprint authentication operation. In the present modification, the memory 34 of the printer 10 may preferably have the fingerprint information 62 stored therein. In the present modification, the memory 34 is an example for “first memory”. In another modification, a terminal device such as a smartphone, instead of the authenticator 50, may accept the fingerprint authentication operation. In this case, the printer 10 may preferably comprise an NFC I/F. In the present modification, the printer 10 executes communication of the fingerprint authentication success information or the like with the terminal device via the NFC I/F. In the present modification, the memory of the terminal device is an example for “first memory”.

(Fifth Modification) The “predetermined information” may not be limited to a serial number, but may be a pre-defined character string and/or predefined information, for example. Resident Key for example may be an example for “predetermined information”. In the present modification, “acquire the predetermined information” may be omitted.

(Sixth Modification) The “device identification information” may not be limited to a serial number, but may be a MAC address, a device name, for example.

(Seventh Modification) T572 in FIG. 10 may be omitted.

(Eighth Modification) In T272 in FIG. 7, the server 200 may delete the RPID “URL1”, the public key PUK1, the user ID “Tanaka”, and the job ID “job1” from the management table 242, and also may delete the print data PD2 from the memory 234.

(Ninth Modification) In each of the above embodiments, the processes in FIGS. 3 to 14 are realized by software (e.g., the programs 40, 140, 240), but at least one of these processes may be realized by hardware such as a logic circuitry.

What is claimed is:

1. A function executing device configured to operate according to a predetermined authentication scheme using a pair of keys, the function executing device comprising:
a function executing engine configured to execute a specific function; and
a controller configured to:
in a case where an input of specific account information is accepted, send a first authentication request including the specific account information to a server;
in response to the first authentication request being sent to the server, receive first verification information from the server;
in a case where an authentication for a target user using biometric information in a first memory succeeds and the first verification information is received from the server, acquire first signature information by encrypting the first verification information using a first private key in the first memory;
send the first signature information to the sever, wherein the server is configured to decrypt the first signature information using a first public key stored in the server in association with the specific account information;
in a case where decryption of the first signature information succeeds in the server, receive a first function executing instruction from the server;
in a case where the first function executing instruction is received from the server, cause the function executing engine to execute the specific function;
send, to the server, a second authentication request including predetermined information without accepting the input of account information;
in response to the second authentication request being sent to the server, receive second verification information from the server;
in a case where the authentication for the target user using the biometric information in the first memory succeeds and the second verification information is received from the server, acquire second signature information by encrypting the second verification information using a second private key in the first memory;
send the second signature information to the sever, wherein the server is configured to decrypt the second signature information using a second public key stored in the server in association with the predetermined information;
in a case where decryption of the second signature information succeeds in the server, receive a second function executing instruction from the server; and
in a case where the second function executing instruction is received from the server, cause the function executing engine to execute the specific function.

2. The function executing device as in claim 1, further comprising a display,
wherein the controller is further configured to, in a case where a predetermined operation is accepted, display on the display a selection screen for selecting whether or not to use account information,
wherein the controller is configured to:
in a case where use of account information is selected on the selection screen and the input of the specific account information is accepted, send the first authentication request to the server; and
in a case where non-use of account information is selected on the selection screen, send the second authentication request to the server without accepting the input of account information.

3. The function executing device as in claim 1, wherein the controller is configured to, in a case where a predetermined operation is accepted, send the second authentication request to the server without accepting the input of account information,
wherein the controller is further configured to, in response to the second authentication request being sent to the server, receive an error response from the server, and
wherein the controller is configured to, in a case where the error request is received from the server and the input of the specific account information is accepted, send the first authentication request to the server.

4. The function executing device as in claim 1, further comprising a second memory configured to store a setting value which indicates one of a first value indicating that use of account information is designated and a second value indicating that non-use of account information is designated,
wherein the controller is configured to:
in a case where the setting value in the second memory indicates the first value and the input of the specific account information is accepted, send the first authentication request to the server; and
in a case where the setting value in the second memory indicates the second value, send the second authentication request to the server without accepting the input of account information.

5. The function executing device as in claim 1, further comprising an interface to which an authenticator comprising the first memory is connected.

6. The function executing device as in claim 5, wherein the predetermined information is device identification information identifying the authenticator,
wherein the controller is further configured to, in a case where the authenticator is connected to the interface, acquire the predetermined information from the authenticator.

7. The function executing device as in claim 1, wherein the server is configured to, in a case where the decryption of the second signature information succeeds, delete the predetermined information and the second public key that are stored in the server, and
even if the decryption by the server of the first signature information succeeds, the specific account information and the first public key that are stored in the server are not deleted.

8. A non-transitory computer-readable recording medium storing computer-readable instructions for a function executing device comprising a processor:
wherein the computer-readable instructions, when executed by the processor, cause the function executing device to:
in a case where an input of specific account information is accepted, send a first authentication request including the specific account information to a server;
in response to the first authentication request being sent to the server, receive first verification information from the server;
in a case where an authentication for a target user using biometric information in a first memory succeeds and the first verification information is received from the server, acquire first signature information by encrypting the first verification information using a first private key in the first memory;
send the first signature information to the sever, wherein the server is configured to decrypt the first signature information using a first public key stored in the server in association with the specific account information;
in a case where decryption of the first signature information succeeds in the server, receive a first function executing instruction from the server;
in a case where the first function executing instruction is received from the server, cause the function executing engine to execute the specific function;
send, to the server, a second authentication request including predetermined information without accepting the input of account information;
in response to the second authentication request being sent to the server, receive second verification information from the server;
in a case where the authentication for the target user using the biometric information in the first memory succeeds and the second verification information is received from the server, acquire second signature information by encrypting the second verification information using a second private key in the first memory;
send the second signature information to the sever, wherein the server is configured to decrypt the second signature information using a second public key stored in the server in association with the predetermined information;
in a case where decryption of the second signature information succeeds in the server, receive a second function executing instruction from the server; and
in a case where the second function executing instruction is received from the server, cause the function executing engine to execute the specific function.

9. A method executed by a function executing device, the method comprising:
in a case where an input of specific account information is accepted, sending a first authentication request including the specific account information to a server;
in response to the first authentication request being sent to the server, receiving first verification information from the server;
in a case where an authentication for a target user using biometric information in a first memory succeeds and the first verification information is received from the server, acquiring first signature information by encrypting the first verification information using a first private key in the first memory;
sending the first signature information to the sever, wherein the server is configured to decrypt the first signature information using a first public key stored in the server in association with the specific account information;
in a case where decryption of the first signature information succeeds in the server, receiving a first function executing instruction from the server;
in a case where the first function executing instruction is received from the server, causing the function executing engine to execute the specific function;
sending, to the server, a second authentication request including predetermined information without accepting the input of account information;
in response to the second authentication request being sent to the server, receiving second verification information from the server;
in a case where the authentication for the target user using the biometric information in the first memory succeeds and the second verification information is received from the server, acquiring second signature information by encrypting the second verification information using a second private key in the first memory;
sending the second signature information to the sever, wherein the server is configured to decrypt the second signature information using a second public key stored in the server in association with the predetermined information;
in a case where decryption of the second signature information succeeds in the server, receiving a second function executing instruction from the server; and
in a case where the second function executing instruction is received from the server, causing the function executing engine to execute the specific function.
